(19) United States
(12) Patent Application Publication
(10) Pub. No.: US 2002/0078116 A1
(43) Pub. Date: Jun. 20, 2002

(54) Method of controlling the operation of an operating system in a computer system

(75) Inventor: Yoshikazu Aoki, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/073,595

(22) Filed: Feb. 12, 2002

Related U.S. Application Data
(63) Continuation of application No. PCT/JP99/04456, filed on Aug. 19, 1999.

(51) Int. Cl. G06F 9/00

(52) U.S. Cl. 709/100

(57) ABSTRACT

Has an object of providing a method of controlling the operation of an operating system in a computer system, and a recording medium recorded with a program for executing this method.

Includes the steps of: preparing or deleting various kinds of files E, R, B, and C that show various operation statuses of a computer system, according to changes in the operation status, and storing the prepared files in a memory section within the computer system; recognizing (S2) a predetermined operation status of the computer system, depending on whether a file corresponding to the predetermined operation status exists within the memory section or not, when a command OSJAR has been started (S1) based on an automatic schedule; and controlling (S3) the operation of the operating system, for example, starting the command OSJAR, according to a result of the recognition.

### CROSS-REFERENCE TO RELATED APPLICATIONS

This application is a continuation of PCT/JP99/04456, filed on Aug. 19, 1999, the contents being incorporated herein by reference.

### TECHNICAL FIELD

The present invention relates to a method of controlling the operation of an operating system in a computer system, and a recording medium on which a program for executing this control method has been recorded. Particularly, this invention relates to a method of starting a job in a computer system that starts the job after recognizing an operation status of the computer system, and a recording medium on which a program for executing this control method has been recorded.

### BACKGROUND ART

Generally, in executing a job as a unit of processing to be executed by a computer, a computer system (hereinafter, to be simply referred to as a system) prepares a job control statement that assigns the defining and controlling of the job by using a job control language (JCL). The system makes a job management program of an operation system (OS) read the job control statement from a job input unit, and monitors the execution of the job based on the job management program.

The OS has an automatic scheduling function for generating an alarm interruption when a pre-assigned time has come or a pre-assigned period has passed, and making a program execute a pre-assigned job based on this alarm interruption.

The system has various operation statuses. For example, there is a status in which the system is accessing a real-time DB (database) to carry out normal operation services, a status in which the system must not access the real-time DB as a batch processing is being carried out, and a status in which the system is accessing the real-time DB only for the purpose of checking a recovery despite being in a time zone in which the system must not access the real-time DB. Depending on the operation statuses of the system, there are jobs that can be executed and jobs that must not be executed.

In a computer system according to the conventional technique, there is no mechanism for automatically recognizing an operation status of the system, and automatically starting a job that can be executed according to the recognized operation status of the system. Therefore, according to the computer system of the conventional technique, it has been necessary that an operator manually starts a job after recognizing an operation status of the system, or it has been necessary to execute a job based on an automatic schedule as follows. Namely, in the latter case, a program for recognizing an operation status of the system is prepared for each job within a program that executes the job based on a flag showing the operation status of the system in conscious of the OS. This program is executed to recognize the operation status of the system, and the job is executed after this recognition. According to the former method, the operator needs to be present at the time of starting the job. According to the latter method, it is necessary to prepare a program for recognizing the operation status of the system by being conscious about the OS for each job. As a result, these methods have had a problem that they require time and labor.

### DISCLOSURE OF INVENTION

Therefore, it is an object of the present invention to provide a mechanism that can automatically recognize an operation status of a computer system and can control the operation of an OS in the computer according to the recognized operation status of the system, by solving the above problem. More specifically, it is an object of the invention to provide a mechanism that can automatically start a job that can be executed in an operation status of the system after this operation status has been recognized. In other words, it is an object of the invention to provide a method of starting a job in a computer system, and a recording medium that has been recorded with a program for executing this method.

In order to achieve the above object of the present invention, according to a first aspect of the invention, there is provided a method of controlling the operation of an operating system in a computer system, the method comprising the steps of: preparing or deleting various kinds of files that show various operation statuses of the computer system, according to changes in the operation status, and storing the prepared files in a memory section within the computer system; recognizing a predetermined operation status of the computer system, depending on whether a file corresponding to the predetermined operation status exists within the memory section or not; and controlling the operation of the operating system according to a result of the recognition.

According to a second aspect of the invention, there is provided a method of controlling the operation of an operating system in a computer system of the above aspect, wherein the control of the operation of the operating system is for starting a predetermined job.

According to a third aspect of the invention, there is provided a method of controlling the operation of an operating system in a computer system of the above aspect, wherein the predetermined job consists of a plurality of programs.

According to a fourth aspect of the invention, there is provided a method of controlling the operation of an operating system in a computer system of the above aspect, wherein the starting of the predetermined job is determined based on whether a plurality of the files exist or not within the memory section.

According to a fifth aspect of the invention, there is provided a method of controlling the operation of an operating system in a computer system of the above aspect, wherein each of the files is provided with an alias, and the operation status of the computer system is recognized based on the alias.

According to a sixth aspect of the invention, there is provided a method of controlling the operation of an operating system in a computer system of the above aspect, the method further comprising the steps of: changing the operation status of the computer system based on a starting of the predetermined job; and starting a second job according to the changed new operation status of the computer system.

Further, in order to achieve the above object of the present invention, according to a seventh aspect of the invention, there is provided a computer-readable recording medium that has been recorded with a program for making a computer execute a method of controlling the operation of an operating system in a computer system, the recording medium being recorded with a program comprising the steps of: preparing or deleting various kinds of files that show various operation statuses of the computer system, according to changes in the operation status, and storing the prepared files in a memory section within the computer system; recognizing a predetermined operation status of the computer system, depending on whether a file corresponding to the predetermined operation status exists within the memory section or not; and controlling the operation of the operating system according to a result of the recognition.

### BRIEF DESCRIPTION OF THE DRAWINGS

FIG. 1 is a diagram showing a first embodiment of a method of starting a job in a computer system according to the present invention.

FIG. 2 is a diagram showing a detailed example of a description statement of OSJAR.

FIG. 3 is a diagram showing a description statement of a command OSJAR that is used in the first embodiment of the present invention shown in FIG. 1.

FIG. 4 is a diagram showing a description statement of a command OSJAR that is used in a second embodiment of the present invention.

### BEST MODE OF CARRYING OUR THE INVENTION

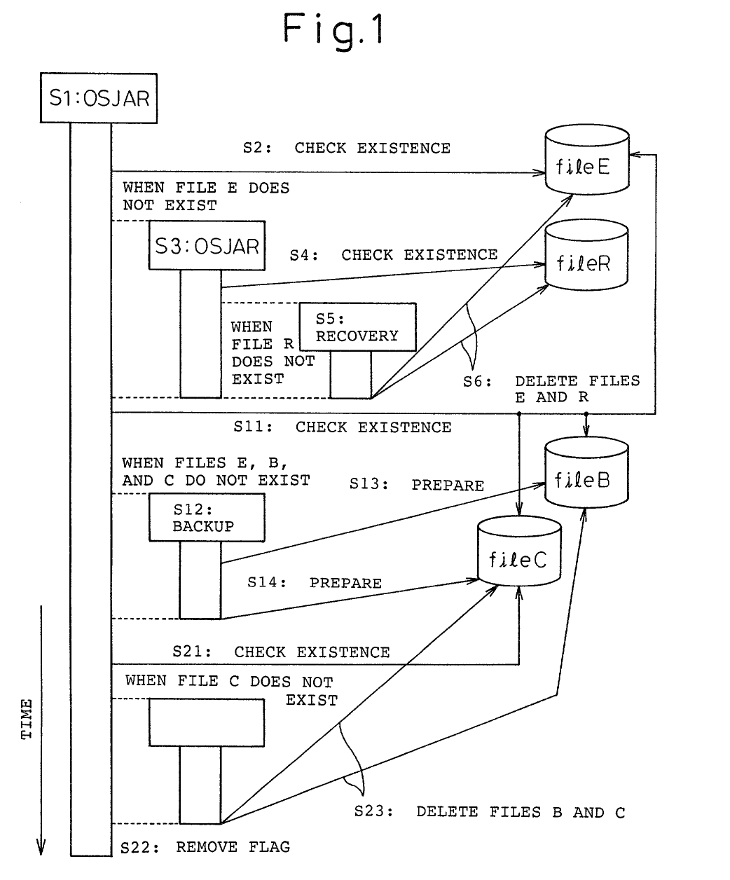

FIG. 1 is a diagram showing a first embodiment of a method of starting a job in a computer system according to the present invention. In FIG. 1, OSJAR denotes a command name. When this command OSJAR has been started at a certain timing, that is, a timing that has been set by an automatic scheduling function of the OS or a timing of an output routine of an application program, a computer recognizes an operation status of the system as explained below. In order to recognize a change in the operation status of the system in substantially real time, the automatic scheduling function of the OS is used to periodically start this command OSJAR in a short period.

A description statement for starting a desired program based on OSJAR will be explained prior to the explanation of the method shown in FIG. 1.

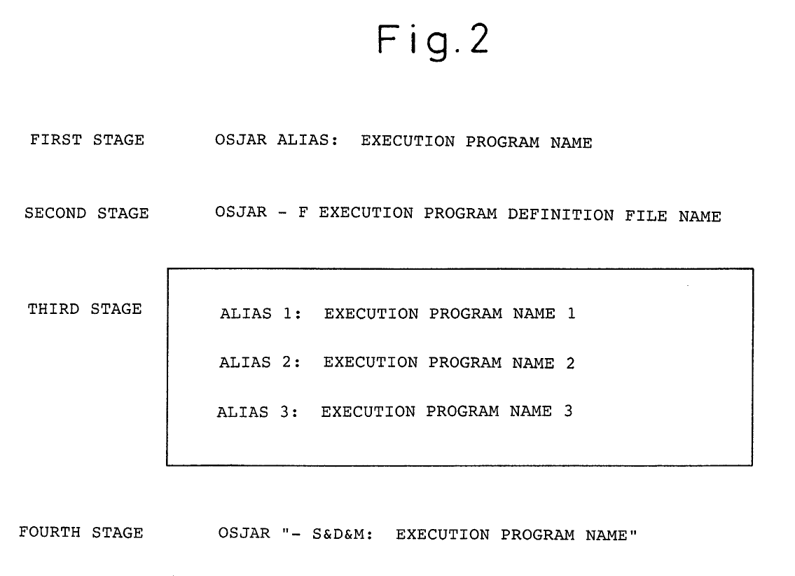

FIG. 2 is a diagram showing a detailed example of the description statement of OSJAR. When it is desired to execute a single program, the following (1) is described, as shown at a first stage in FIG. 2.

OSJAR alias: execution program name—(1) (In this case, alias has a meaning of another name.) Based on this description, a program that has this execution program name is executed.

When it is desired to execute a plurality of programs, the following (2) is described, as shown at a second stage in FIG. 2.

OSJAR—f execution program definition file name—(2)

Following the above description, execution program names 1 to 3 are described in the file of execution program definition file names as described in a block at a third stage in FIG. 2. Then, three programs that have the execution program names 1 to 3 are executed sequentially.

If it is desired to execute a single program when a desired condition has been satisfied, the following (3) is described, as shown at a fourth stage in FIG. 2.

OSJAR “—S&D&M: execution program name”—(3) Based on this description, a program that has this execution program name is executed after the condition S&D&M has been satisfied. In this case,—shows a NOT condition, and & shows an AND condition.

Files S, D, and M are defined in advance respectively as follows.

A name of a file that is prepared at the time of starting the system is defined as file S alias=S.

A name of a file that is prepared at the time of operating the system in the daytime is defined as file D alias=D.

A name of a file that is prepared at the time of a maintenance operation is defined as file M alias=M.

Therefore,—S&D&M means that the condition that the file S does not exist but the file D and the file M exist is satisfied. Assume that it is desired to execute a program of an execution program name in the daytime operation and at the maintenance time but not at the system starting time. In this case, it is understood that the system operation status is that the file S does not exist but the file D and the file M exist. The program name is described as shown in (3) above.

An OR condition is expressed by using |.

Further, ( ) is used to provide a condition that has a high priority. For example, “(A&B)|(C&D): execution program name” means that a program of the execution program name is executed when the condition of A&B or C&D has been satisfied.

The method shown in FIG. 1 will be explained next.

In FIG. 1, a file E, a file R, a file B, and a file C show files that have the following file names respectively.

file B alias=B shows a name of a file that is prepared at the time of a backup.

file E alias=E shows a name of a file that is prepared at the time of a backup error.

file R alias=R shows a name of a file that is prepared when recovery is possible.

file C alias=C shows a name of a file that is prepared when a backup has been finished normally.

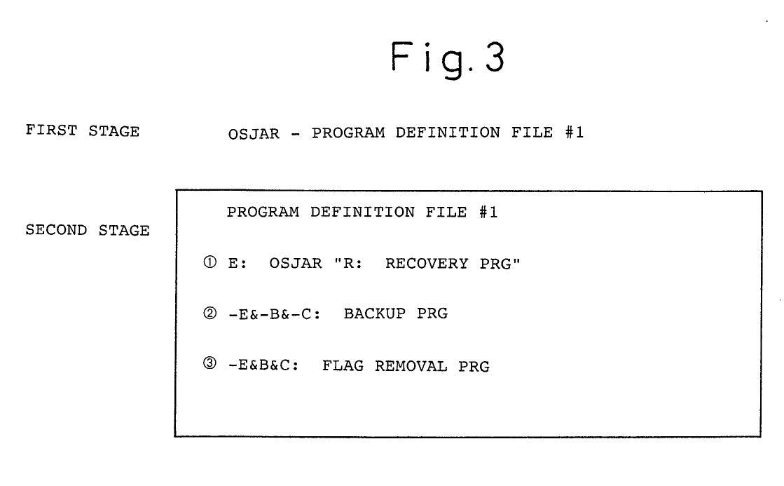

FIG. 3 is a diagram showing a description statement of a command OSJAR that is used in the first embodiment of the present invention shown in FIG. 1. A first embodiment of the present invention will be explained below with reference to FIG. 1 and FIG. 3.

At a first stage in FIG. 3, there is the following description.

OSJAR—program definition file #1 Therefore, a command OSJAR is executed at a first step S1. In other words, the following programs \hat{1}, \hat{2}, and \hat{3} that are shown in a program definition file #1 at a second stage in FIG. 3 are read.

\hat{1} E: OSJAR “R: recovery Prg”

\hat{2}—E&-B&-C: backup Prg

\hat{3}—E&B&C: flag removal Prg

At step S2, the execution of the program \hat{1} is started, and the existence of the file E is checked. In this example, it is judged that the file E does not exist, and OSJAR in 0 is executed at step S3. At step S4, the existence of the file R is checked. In this example, it is judged that the file R exists. At step S5, the recovery Prg is executed. When the recovery Prg has been executed and the recovery Prg has been finished at step S5, the file E and the file R are deleted at step S6.

Next, at step S11, the execution of the program at \hat{2} is started, and the existence of the files E, B and C is checked. In this example, it is judged that the files E, B and C do not exist, and the backup Prg is executed at step S12. At the time of executing the backup Prg, when the backup at the last time ended with an error, the backup Prg of \hat{2} is executed after the recovery Prg of \hat{1} has been executed. When the backup Prg at the last time has been finished normally, the flag removal Prg of \hat{3} is executed.

When the execution of the backup Prg has been started at step S12, the file B is prepared at step S13. When the backup has been a failure although this is not shown is the drawing, the file E is prepared, and the file R is prepared when recovery is possible. When the backup has been finished normally, the file C is prepared at step S14.

Next, at step S21, the execution of the program \hat{3} is started, and the existence of the file C is checked. In this example, it is judged that the file C does not exist, and the flag removal Prg \hat{3} is executed at step S22. When the flag removal Prg has been executed and the flag removal Prg has been finished at step S22, the file B and the file C are deleted at step S23.

As is clear from the above first embodiment, according to the present invention, various kinds of files are provided corresponding to various operation statuses of the system. The operation status of the system is recognized based on the presence or absence of these files. When it is not possible to execute a predetermined program according to the operation status of the system, it is possible to execute the command OSJAR in the above command OSJAR \hat{1}. Therefore, it is possible to automatically update the operation status of the system after judging a certain operation status of the system. It is also possible to execute a predetermined program after changing the operation status. For example, it is possible to execute the backup after executing the recovery.

Next, a second embodiment will be explained.

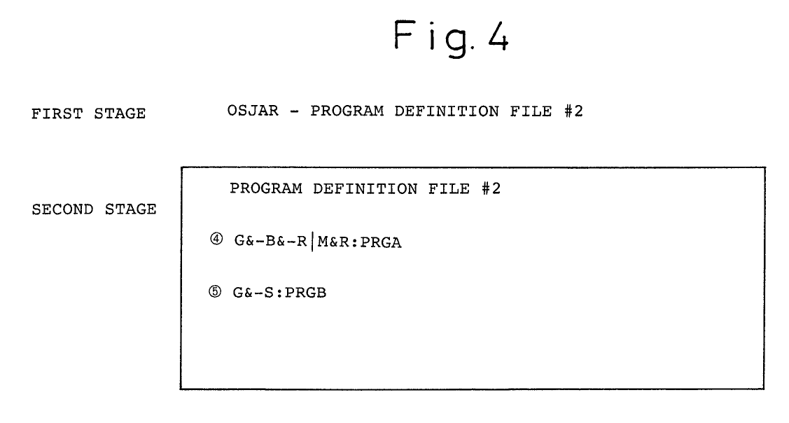

FIG. 4 is a diagram showing a description statement of a command OSJAR that is used in a second embodiment of the present invention.

At a first stage in FIG. 4, there is the following description.

OSJAR—program definition file #2

Therefore, a command OSJAR is executed at a first step. In other words, the following programs \hat{4} and \hat{5} that are shown in a program definition file #2 at a second stage in FIG. 4 are read.

The execution of a program A and a program B is started when the starting conditions described before of \hat{4} and \hat{5} have been satisfied respectively.

G&-B&-R|M&R: Prg A—(4)

G&-S: Prg B—(5)

The Prg A shows a program for accessing a DB, and the Prg B shows a program for confirming the capacity of a disk. G, M, R, B, and S denote files that show the operation status of the computer system respectively. G denotes a file that shows a normal operation status. M denotes a file that shows a maintenance operation status. R denotes a file that shows a recovery operation status. B denotes a file that shows a batch operation status. S denotes a file that shows a backup operation status. These files are prepared/deleted as follows.

The file G is prepared in a starting procedure when the system has been started for a normal operation. This file is deleted in a shutdown procedure when the system has been shut down.

The file M is prepared in a starting procedure when the system has been started for a maintenance operation. This file is deleted in a shutdown procedure when the system has been shut down.

The file R is prepared at a start of a recovery, and is deleted when the recovery has been finished.

The file B is prepared by a batch program at the time of starting a batch operation, and is deleted by the batch program when the batch operation has been finished.

The file S is prepared by a backup program at the time of starting a backup, and is deleted by the backup program when the backup has been finished.

The execution of the program A and the program B is started when the starting conditions shown in (\hat{4} and \hat{5} above have been satisfied respectively.

Therefore, the program A is executed when the system is in the normal operation status (when the file G is present), not in the batch operation status (when the file B is not present), and not in the recovery operation status (when the file R is not present). Alternatively, the program A is executed when the system is in the maintenance operation status (when the file M exists), and in the recovery operation status (when the file R exists) as well.

On the other hand, the program B is executed when the system is in the normal operation status (when the file G is present), and not in the backup operation status (when the file S does not exist).

As is clear from the above second embodiment, according to the present invention, various kinds of files are provided corresponding to various operation statuses of the system. The operation status of the system is recognized based on the presence or absence of these files. It is possible to execute a predetermined program according to the operation status of the system.

Next, the processing of a program that has been recorded on a recording medium for making a computer execute the method of starting a job in a computer system of the present invention will be explained.

A computer system of the present invention comprises a central processing unit (CPU), a main memory unit consisting of a RAM or the like as a recording medium, an auxiliary memory unit consisting of a magnetic disk or the like as a recording medium, an input section consisting of a keyboard, a mouse, or the like, and an output section consisting of a CRT, a printer, or the like. Various kinds of files that are prepared and deleted corresponding to various operation statuses of the present invention are stored in the magnetic disk.

OS and application programs are suitably written into the main memory unit. A program for making the computer execute a method of starting a job in the computer system of the present invention is also written into the main memory unit based on the following various methods.

The central processing unit (CPU) incorporates a recording unit of a portable recording medium like a CD-ROM and a floppy disk. The CPU reads the program of the present invention that has been recorded on the portable recording medium like the CD-ROM and the floppy disk via a reading unit, based on a predetermined operation. The CPU loads the read program onto the main memory unit. It is of course possible to arrange such that an operator directly writes the program onto the main memory unit of the computer system via an input unit (not shown) like a keyboard and a mouse, and installs the program on the auxiliary memory unit. Alternatively, via a network (a communication line), the program stored in the auxiliary memory unit like a magnetic disk as a recording medium that is installed on the computer of other client is loaded onto the auxiliary memory unit of the computer system according to the present invention. Thereafter, the program stored in the auxiliary memory unit is loaded onto the main memory unit according to the needs, based on the processing of the central processing unit. The central processing unit executes the program written on the main memory unit, according to the needs.

As explained above, according to the present invention, it is possible to prepare a mechanism for automatically recognizing the operation status of the computer system, and controlling the operation of the OS in the computer according to the recognized operation status of the system.

Further, according to the present invention, it is possible to provide a method of starting a job in the computer system for automatically starting the job that can be executed in an operation status of the system after this operation status has been recognized. It is also possible to provide a recording medium that has been recorded with a program for executing this method.

1. A method of controlling the operation of an operating system in a computer system, the method comprising the steps of:
preparing or deleting various kinds of files that show various operation statuses of the computer system, according to changes in the operation status, and storing the prepared files in a memory section within the computer system;
recognizing a predetermined operation status of the computer system, depending on whether a file corresponding to the predetermined operation status exists within the memory section or not; and
controlling the operation of the operating system according to a result of the recognition.

2. The method of controlling the operation of an operating system in a computer system according to claim 1, wherein
the control of the operation of the operating system is for starting a predetermined job.

3. The method of controlling the operation of an operating system in a computer system according to claim 2, wherein
the predetermined job consists of a plurality of programs.

4. The method of controlling the operation of an operating system in a computer system according to claim 2, wherein
the starting of the predetermined job is determined based on whether a plurality of the files exist or not within the memory section.

5. The method of controlling the operation of an operating system in a computer system according to claim 3, wherein
the starting of the predetermined job is determined based on whether a plurality of the files exist or not within the memory section.

6. The method of controlling the operation of an operating system in a computer system according to claim 1, wherein
each of the files is provided with an alias, and the operation status of the computer system is recognized based on the alias.

7. The method of controlling the operation of an operating system in a computer system according to claim 2, wherein
each of the files is provided with an alias, and the operation status of the computer system is recognized based on the alias.

8. The method of controlling the operation of an operating system in a computer system according to claim 3, wherein
each of the files is provided with an alias, and the operation status of the computer system is recognized based on the alias.

9. The method of controlling the operation of an operating system in a computer system according to claim 4, wherein
each of the files is provided with an alias, and the operation status of the computer system is recognized based on the alias.

10. The method of controlling the operation of an operating system in a computer system according to claim 5, wherein
each of the files is provided with an alias, and the operation status of the computer system is recognized based on the alias.

11. The method of controlling the operation of an operating system in a computer system according to claim 6, the method further comprising the steps of:
changing the operation status of the computer system based on a starting of the predetermined job; and
starting a second job according to the changed new operation status of the computer system.

12. The method of controlling the operation of an operating system in a computer system according to claim 7, the method further comprising the steps of:
changing the operation status of the computer system based on a starting of the predetermined job; and
starting a second job according to the changed new operation status of the computer system.

13. The method of controlling the operation of an operating system in a computer system according to claim 8, the method further comprising the steps of:
changing the operation status of the computer system based on a starting of the predetermined job; and
starting a second job according to the changed new operation status of the computer system.

14. The method of controlling the operation of an operating system in a computer system according to claim 9, the method further comprising the steps of:
changing the operation status of the computer system based on a starting of the predetermined job; and
starting a second job according to the changed new operation status of the computer system.

15. The method of controlling the operation of an operating system in a computer system according to claim 10, the method further comprising the steps of:
changing the operation status of the computer system based on a starting of the predetermined job; and
starting a second job according to the changed new operation status of the computer system.

16. A computer-readable recording medium that has been recorded with a program for making a computer execute a method of controlling the operation of an operating system in a computer system, the recording medium being recorded with a program comprising the steps of:
preparing or deleting various kinds of files that show various operation statuses of the computer system, according to changes in the operation status, and storing the prepared files in a memory section within the computer system;
recognizing a predetermined operation status of the computer system, depending on whether a file corresponding to the predetermined operation status exists within the memory section or not; and
controlling the operation of the operating system according to a result of the recognition.
